(19) United States
(12) Patent Application Publication
(10) Pub. No.: US 2023/0089311 A1
(43) Pub. Date: Mar. 23, 2023

(54) BUFFER STRUCTURE FOR LID OF GRILL STOVE

(71) Applicant: REVOACE INC.LIMITED, Hong Kong (CN)

(72) Inventor: Kiosky Chung, Hong Kong (CN)

(21) Appl. No.: 17/481,238

(22) Filed: Sep. 21, 2021

(51) Int. Cl. A47J 37/07

(52) U.S. Cl. CPC A47J 37/07

(57) ABSTRACT

A buffer structure of a lid for a grill stove contains: a body, the lid, two bolts, and two torsion springs. The body includes a grilling zone, a first rotatable seat, and a second rotatable seat. The first rotatable seat has two first rotatable connection tabs, and each first rotatable connection tab has a first through orifice. The lid includes a third rotatable seat and a fourth rotatable seat. The third rotatable seat has two second rotatable connection tabs, and each second rotatable connection tab has a second through orifice. The two bolts are inserted through the first rotatable seat, the third rotatable seat, the second rotatable seat, and the fourth rotatable seat. Each torsion spring is fitted with each bolt and abuts against the first rotatable seat, the second rotatable seat, the third rotatable seat, and the fourth rotatable seat.

### FIELD OF THE INVENTION

The present invention relates to a buffer structure or a lid of a grill stove according to a preferred embodiment of the present invention is capable of enhancing using safety when covering or uncovering the lid.

### BACKGROUND OF THE INVENTION

Conventional grill is to cook food on the fire until it is edible. Since most meat is cooked, grill is also called barbecue. In modern society, barbecue has become a multi-person gathering leisure and entertainment. With the diversification of barbecues, various grill stoves have appeared on the market for consumers to use.

A conventional grill stove contains a grill mesh, a grilling zone formed on a top of the grill stove, and a lid configured to cover the grilling zone.

However, it is easy to blow the lid to drop on a ground when strong winds occur. In addition, the lid will cover unsafely when touching the lid suddenly.

The present invention has arisen to mitigate and/or obviate the afore-described disadvantages.

### SUMMARY OF THE INVENTION

The primary aspect of the present invention is to provide a buffer structure of a lid for a grill stove according to a preferred embodiment of the present invention is capable of enhancing using safety when covering or uncovering the lid.

To obtain the above mentioned aspects, a buffer structure of a lid for a grill stove provided by the present invention contains: a body, the lid, two bolts, and two torsion springs.

The body includes a grilling zone defined on a top thereof, a first rotatable seat and a second rotatable seat which are arranged in the grilling zone.

The first rotatable seat and the second rotatable seat are hollow, the first rotatable seat has two first rotatable connection tabs extending from two sides thereof, and each of the two first rotatable connection tabs has a first through orifice.

The lid is covered onto the grilling zone and is movably fixed on the body, and the lid includes a third rotatable seat and a fourth rotatable seat which are rotatably connected on a rear end of the lid.

The third rotatable seat and the fourth rotatable seat are hollow, the third rotatable seat has two second rotatable connection tabs extending from two sides thereof, and each of the two second rotatable connection tabs has a second through orifice, such that each first rotatable connection tab of the first rotatable seat corresponds to each second rotatable connection tab of the third rotatable seat, and each third rotatable connection tab of the second rotatable seat corresponds to each fourth rotatable connection tab of the fourth rotatable seat.

The two bolts are inserted through the first through orifice of each first rotatable connection tab of the first rotatable seat, the second through orifice of each second rotatable connection tab of the third rotatable seat, a third through orifice of each third rotatable connection tab of the second rotatable seat, and a fourth through orifice of each fourth rotatable connection tab of the fourth rotatable seat.

Each of the two torsion springs is fitted with each of the two bolts, and each torsion spring abuts against the first rotatable seat, the second rotatable seat, the third rotatable seat, and an extension of the fourth rotatable seat.

### BRIEF DESCRIPTION OF THE DRAWINGS

FIG. 1 is a perspective view showing the exploded components of a part of a buffer structure of a lid for a grill stove according to a preferred embodiment of the present invention.

FIG. 2 is a perspective view showing the operation of the buffer structure of the lid for the grill stove according to the preferred embodiment of the present invention.

FIG. 3 is another perspective view showing the operation of the buffer structure of the lid for the grill stove according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

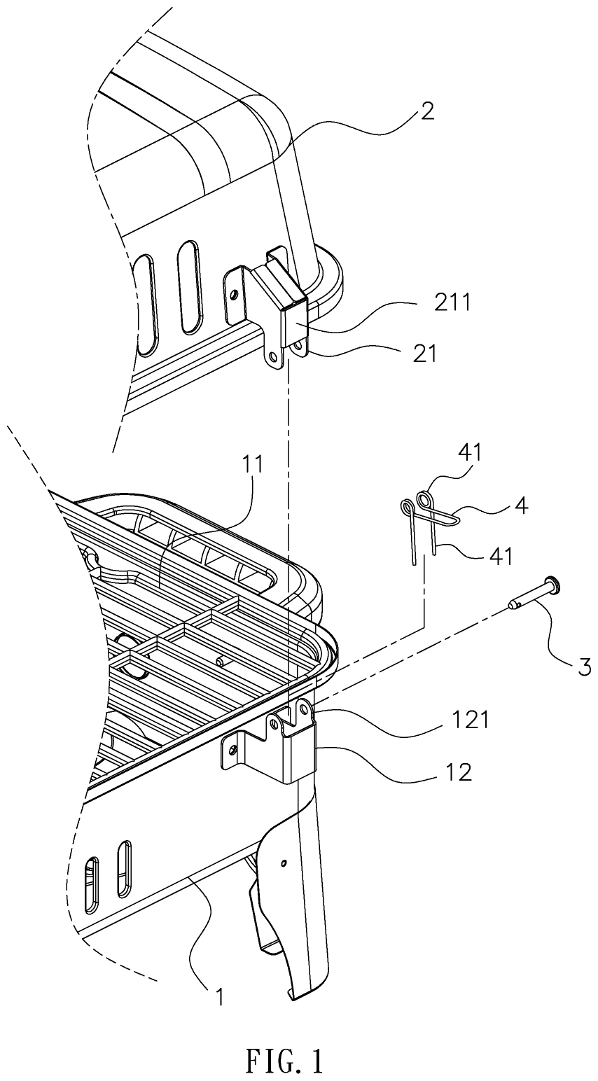

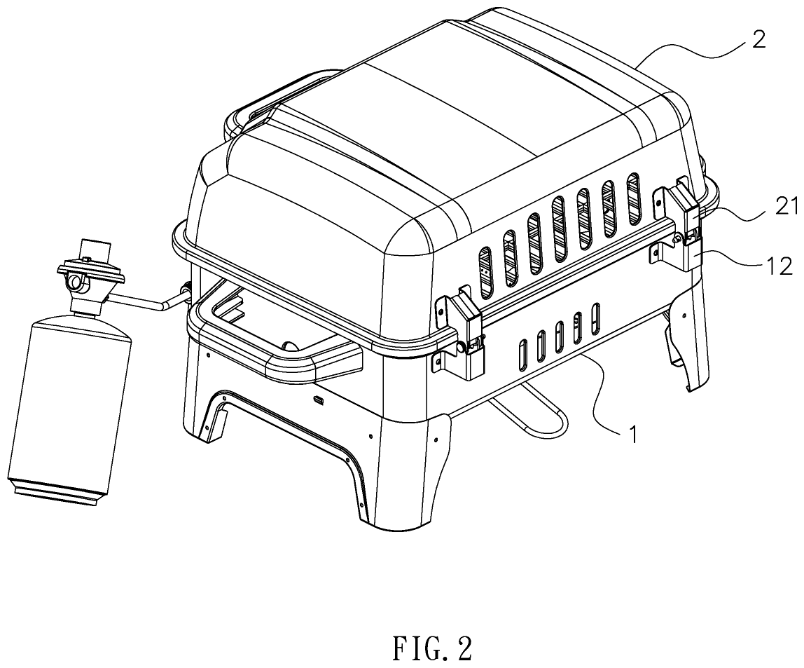

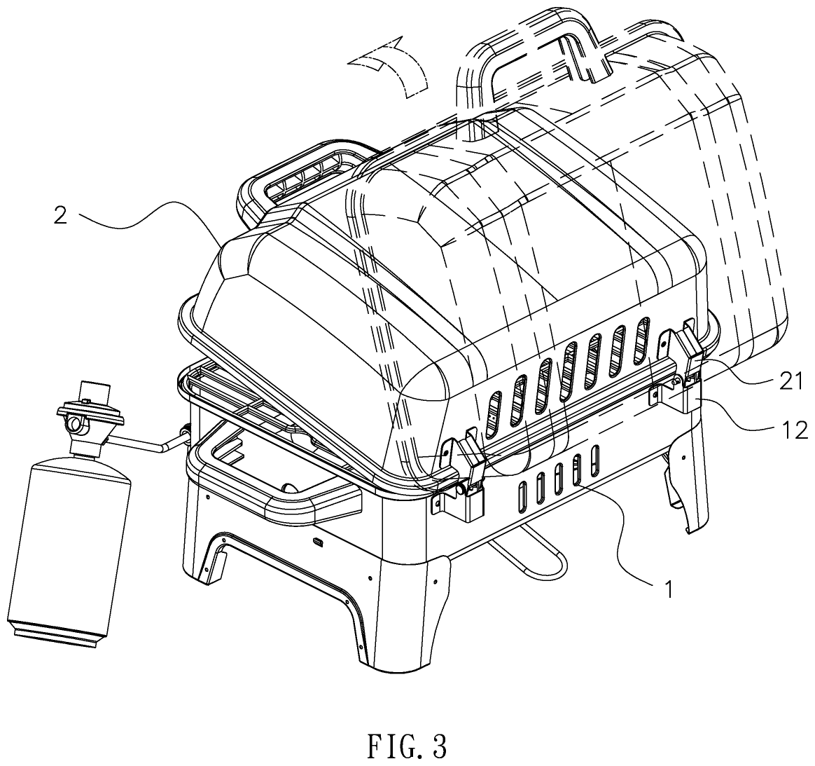

With reference to FIGS. 1-3, a buffer structure for a lid of a grill stove according to a preferred embodiment of the present invention is capable of enhancing using safety when covering or uncovering the lid.

The buffer structure of the present invention comprises: a body 1, the lid 2, two bolts 3, and two torsion springs 4.

The body 1 includes a grilling zone 11 defined on a top thereof, a first rotatable seat 12 and a second rotatable seat which are arranged in the grilling zone 11, wherein the second rotatable seat corresponds to the first rotatable seat 12, so it is not shown in drawings.

The first rotatable seat 12 and the second rotatable seat are hollow, the first rotatable seat 12 has two first rotatable connection tabs 121 extending from two sides thereof, and each of the two first rotatable connection tabs 121 has a first through orifice.

The lid 2 is covered onto the grilling zone 11 and is movably fixed on the body 1. The lid 2 includes a third rotatable seat 21 and a fourth rotatable seat which are rotatably connected on a rear end of the lid 2, wherein the fourth rotatable seat corresponds to the third rotatable seat, so it is not shown in drawings.

The third rotatable seat 21 and the fourth rotatable seat are hollow, the third rotatable seat 21 has two second rotatable connection tabs 211 extending from two sides thereof, and each of the two second rotatable connection tabs 211 has a second through orifice, such that each first rotatable connection tab 121 of the first rotatable seat 12 corresponds to each second rotatable connection tab 211 of the third rotatable seat 21, and each third rotatable connection tab of the second rotatable seat corresponds to each fourth rotatable connection tab of the fourth rotatable seat.

The two bolts 3 are inserted through the first through orifice of each first rotatable connection tab 121 of the first rotatable seat 12, the second through orifice of each second rotatable connection tab 211 of the third rotatable seat 21, a third through orifice of each third rotatable connection tab of the second rotatable seat, and a fourth through orifice of each fourth rotatable connection tab of the fourth rotatable seat.

Each of the two torsion springs 4 is fitted with each of the two bolts 3, and each torsion spring 4 abuts against the first rotatable seat 12, the second rotatable seat, the third rotatable seat 21, and an extension 41 of the fourth rotatable seat.

Accordingly, each torsion spring 4 is configured to provide flexibility to the body 1 and the lid 2 so as to buffer a covering and an uncovering of the lid 2.

Thereby, the buffer structure of the present invention is capable of enhancing using safety when covering or uncovering the lid.

While various embodiments in accordance with the present invention have been shown and described, it is clear to those skilled in the art that further embodiments may be made without departing from the scope of the present invention.

What is claimed is:

1. A buffer structure for a lid of a grill stove comprising: a body, the lid, two bolts, and two torsion springs;
wherein the body includes a grilling zone defined on a top thereof, a first rotatable seat and a second rotatable seat which are arranged in the grilling zone;
wherein the first rotatable seat and the second rotatable seat are hollow, the first rotatable seat has two first rotatable connection tabs extending from two sides thereof, and each of the two first rotatable connection tabs has a first through orifice;
wherein the lid is covered onto the grilling zone and is movably fixed on the body, and the lid includes a third rotatable seat and a fourth rotatable seat which are rotatably connected on a rear end of the lid;
wherein the third rotatable seat and the fourth rotatable seat are hollow, the third rotatable seat has two second rotatable connection tabs extending from two sides thereof, and each of the two second rotatable connection tabs has a second through orifice, such that each first rotatable connection tab of the first rotatable seat corresponds to each second rotatable connection tab of the third rotatable seat, and each third rotatable connection tab of the second rotatable seat corresponds to each fourth rotatable connection tab of the fourth rotatable seat;
wherein the two bolts are inserted through the first through orifice of each first rotatable connection tab of the first rotatable seat, the second through orifice of each second rotatable connection tab of the third rotatable seat, a third through orifice of each third rotatable connection tab of the second rotatable seat, and a fourth through orifice of each fourth rotatable connection tab of the fourth rotatable seat;
wherein each of the two torsion springs is fitted with each of the two bolts, and each torsion spring abuts against the first rotatable seat, the second rotatable seat, the third rotatable seat, and an extension of the fourth rotatable seat.
